(19) United States
(12) Patent Application Publication
(10) Pub. No.: US 2010/0225938 A1
(43) Pub. Date: Sep. 9, 2010

(54) IMAGE-PROCESSING APPARATUS, IMAGE-FORMING APPARATUS, AND IMAGE-PROCESSING METHOD

(75) Inventor: Noriaki Nara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/625,978

(22) Filed: Nov. 25, 2009

(30) Foreign Application Priority Data
Mar. 3, 2009 (JP) 2009-049431

(51) Int. Cl. G06F 15/00

(52) U.S. Cl. 358/1.9; 358/1.16

(57) ABSTRACT

An image-processing apparatus includes: a memory that stores a red range defining red in a color space; an acquiring unit that acquires original image data representing an original image including a first part whose color is the red defined by the red range and a second part whose color is a color other than the red; and a generating unit that generates modified image data representing a modified image in which a density of either the first part or the second part is reduced to a density smaller than a density of the original image represented by the acquired original image data.

### CROSS-REFERENCE TO RELATED APPLICATIONS

This application is based on and claims priority under 35 USC 119 from Japanese Patent Application No. 2009-49431 filed on Mar. 3, 2009.

### BACKGROUND

### Technical Field

The present invention relates to an image-processing apparatus, an image-forming apparatus, and an image-processing method.

### SUMMARY

According to an aspect of the invention, there is provided an image-processing apparatus including: a memory that stores a red range defining red in a color space; an acquiring unit that acquires original image data representing an original image including a first part whose color is the red defined by the red range and a second part whose color is a color other than the red; and a generating unit that generates modified image data representing a modified image in which a density of either the first part or the second part is reduced to a density smaller than a density of the original image represented by the acquired original image data.

### BRIEF DESCRIPTION OF THE DRAWINGS

Exemplary embodiment of the present invention will be described in detail based on the following figures, wherein:

FIG. 1 is a diagram showing an overall configuration of a system according to an exemplary embodiment of the present invention;

FIG. 2 is a block diagram showing a configuration of an image-forming apparatus 1 according to the same exemplary embodiment;

FIG. 3 is a block diagram showing a configuration of an information processing apparatus 3 according to the same exemplary embodiment;

FIG. 4 is a flowchart showing operations performed when information processing apparatus 3 executes a printer driver, according to the same exemplary embodiment;

FIG. 5 is a diagram showing a pop-up window 5 for confirming whether to execute emphasis support processing in the same exemplary embodiment;

FIG. 6 is a diagram showing a pop-up window 6 for setting a detail of emphasis support processing in the same exemplary embodiment;

FIG. 7 is a diagram showing document images after execution of emphasis support processing according to the same exemplary embodiment; and

FIG. 8 is a diagram showing an image after emphasis support processing according to a modified example.

### DETAILED DESCRIPTION

The retinas of the eyes of a typical individual with normal color vision contain three types of cones, or red, green, and blue cones, whose sensations (spectral sensitivities) differ depending on the wavelength of light. However, color-blind individuals have differences in cones and in spectral sensitivities as compared to those individuals who have normal color vision, and thus have less information with which to distinguish between hues such as red, yellow, and blue. Color-blind individuals can therefore distinguish colors based only on differences in saturation and brightness. Meanwhile, there are several different types of color blindness; for example, there are cases where red hues cannot be recognized, making it difficult to distinguish between red and achromatic colors such as black. Red is often used in materials that present information, such as documents, to highlight content that is important, content to be emphasized, content that is to elicit the attention of a user, and so on. It follows that if a user cannot adequately distinguish red text, the attention of the reader to such portions of text will not be elicited. Hereinafter, an exemplary embodiment of the present invention shall be described with reference to a document that has been modified with red, as an example. Note that the following descriptions assume the use of the RGB color space, which is one type of an additive color mixture that reproduces a wide range of colors by mixing of three base colors, red, green, and blue, where each of those base colors is expressed as 8 bits (256 tones). In the following “red” is used to refer to those colors expressed within an R, G, B range of R=225, G=0 to 51, B=0 to 51.

(Configuration)

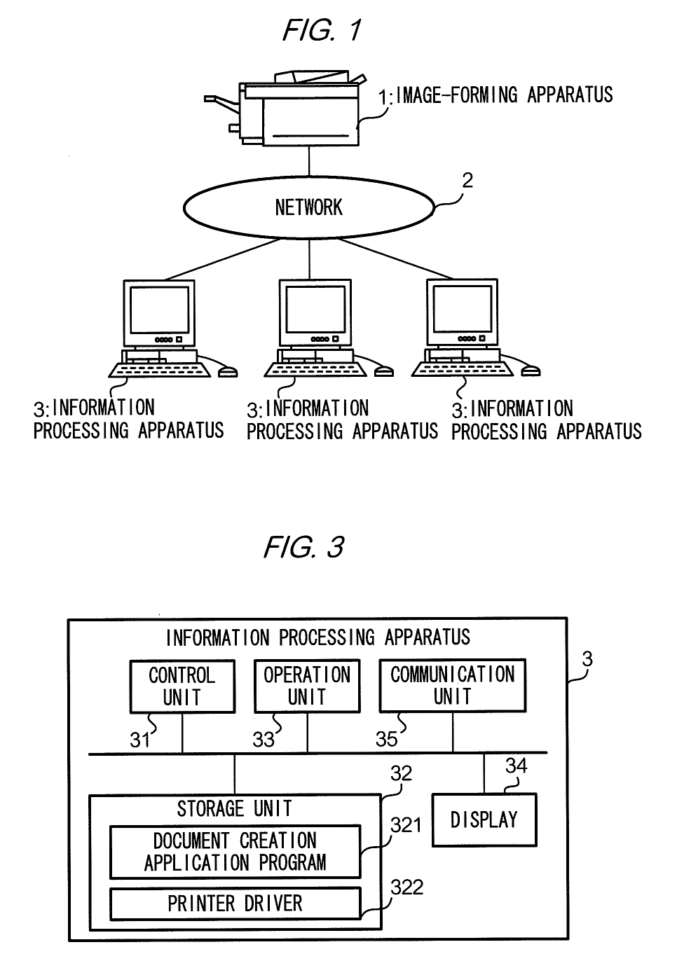

FIG. 1 is a diagram showing an overall configuration of a system according to the present exemplary embodiment. An image-forming apparatus 1 and an information processing apparatus 3 are connected via a network 2, which is a communications network such as a WAN (Wide Area Network) or a LAN (Local Area Network) used for transmitting information. Image-forming apparatus 1 is a device that consolidates functions such as copying, printing, and scanning into a single device, and forms images on a recording medium, reads images from the recording medium, and so on. Information processing apparatus 3 is, for example, a personal computer, and performs various types of image processes, supplies image data to image-forming apparatus 1 via network 2 and instructs image-forming apparatus 1 to form images based on the supplied image data, and so on. Although FIG. 1 shows a single image-forming apparatus 1 and three information processing apparatuses 3, it is to be noted that the number of apparatus shown is for illustrative purposes only and a number of image-forming apparatuses 1 and information processing apparatuses 3 connected to network 2 is not limited thereto.

FIG. 2 is a block diagram showing a configuration of image-forming apparatus 1. Image-forming apparatus 1 includes a control unit 11, a storage unit 12, an operation unit 13, a display 14, a communication unit 15, an image-reading unit 16, and an image-forming unit 17. Control unit 11 includes a CPU (Central Processing Unit), a ROM (Read Only Memory), and a RAM (Random Access Memory), and controls the various units of image-forming apparatus 1 by the CPU executing programs stored in the ROM, storage unit 12, and so on. Storage unit 12 includes a non-volatile supplementary storage device such as a HD (Hard Disk), in which are stored various programs, data, and so on. Operation unit 13 includes multiple keys, accepts operations performed by a user, and supplies signals based on the operations to control unit 11. Display 14 includes a VRAM (Video RAM), a liquid-crystal display, and a liquid-crystal driving circuit, and displays progress of processing based on information supplied by control unit 11, information for guiding the operations performed by the user, and so on. Communication unit 15 includes a communication circuit and a communication interface, and communicates with information processing apparatus 3 via network 2. Image-reading unit 16 includes an optical system member including a CCD (Charge Coupled Device), and reads an image formed on a recording medium using the optical system member, thereby generating image data representing the read image. Image-forming unit 17 includes a photosensitive drum that serves as an image carrier, an exposure unit that forms an electrostatic latent image, a developing unit that develops the electrostatic latent image and forms a toner image, a transfer unit that transfers the toner image to a recording medium, and a fixing unit that fixes the toner image transferred to the recording medium onto that recording medium. Image-forming unit 17 is one example of an image-forming unit that forms an image on a recording medium based on image data generated by image-reading unit 16, or image data received at image-forming unit 17 via communication unit 15.

FIG. 3 is a block diagram showing a configuration of information processing apparatus 3. Information processing apparatus 3 includes a control unit 31, a storage unit 32, an operation unit 33, a display 34, and a communication unit 35. Control unit 31 includes a CPU, a ROM, and a RAM, and controls various units of information processing apparatus 3 by execution by the CPU of programs stored in the ROM, storage unit 32, and so on. Operation unit 33 includes an operating device, such as a keyboard, a mouse, or the like, that accepts operations from a user and supplies signals based on those operations to control unit 31. Display 34 is one example of a display unit that includes a display device, such as a CRT display, a liquid-crystal display (LCD), or the like. Display 34 displays various items of information based on image data supplied by control unit 31, which is an example of a display controller. Communication unit 35 includes a communication circuit and a communication interface, and communicates with image-forming apparatus 1 via network 2.

Storage unit 32 includes a non-volatile supplementary storage device such as an HD, in which there are stored various programs, data, and so on. The programs stored in storage unit 32 include a document creation application program 321 in which there are denoted procedures for creating, editing, and saving document image data representing a document in which text, diagrams, tables, and the like are represented by use of various colors, and a printer driver 322 in which there are denoted processing procedures for converting the document image data into image data that is expressed in page description language for processing by image-forming apparatus 1. The aforementioned red range occurring in the RGB color space, where (R, G, B=255, 0 to 51, 0 to 51), and the black range occurring in the RGB color space, where (R, G, B=0, 0, 0), are defined by printer driver 322. In other words, storage unit 32, in which printer driver 322 is stored, is one example of a memory that stores each of a red range and a black range. Furthermore, a processing procedure for enabling color-blind individuals to recognize parts of document image data, which parts have been created in preparation of the document by a user who executes document creation application program 321, and which are highlighted in red for a purpose of eliciting a user's attention, hereinafter, “emphasis support processing,” are denoted in printer driver 322. Emphasis support processing is used for implementing shade reduction in image regions expressed in a particular color. Control unit 31 reduces shades in image regions expressed in a determined color in document image data of a document. Accordingly, a difference in brightness between, for example, a red color used for emphasizing a particular part(s) of the document and other color(s) used in the document (typically, black, which is the most commonly used color in documents), is effected, and as a result it becomes possible for color-blind individual to differentiate the different colors used in the document (in the present example, red and black). Here, the term “shade reduction” is used to refer to a reduction in a density of an image, and more specifically, to a reduction in an area of toner covering a surface of a recording medium per unit area as compared to coverage by the toner prior to shade reduction. Shade reduction can be effected by reducing a size of dots formed with a toner on a surface of a recording medium, or by reducing an overall thickness of lines formed with the toner.

Emphasis support processing consists of 4 different modes, namely, “a: shade reduction of black,” “b: shade reduction of colors other than red,” “c: shade reduction of red,” and “d: shade reduction of colors other than black.” Hereinafter, these modes are referred to as “process modes,” as carried out in an emphasis support operation. In addition, 3 different kinds of density level are possible, namely, “strong,” “medium,” and “weak,” one of which may be expressed in an image after implementation of shade reduction in the image. Assuming that a density of an image formed without any emphasis support processing is 100%, an image density shade reduction at the “strong” level could be 50%, while that at the “middle” level and the “weak” level could be 54% and 63%, respectively. Implementation of density levels may be set by a designer of printer driver 322, or by a user.

(Operations)

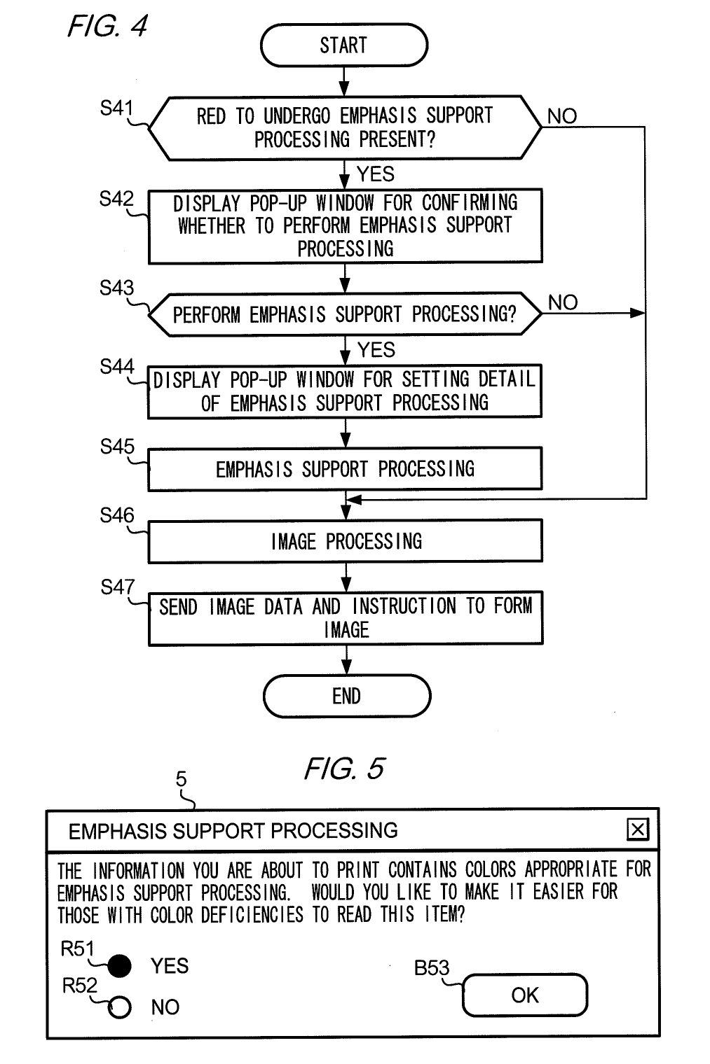

A user causes information processing apparatus 3 to execute document creation application program 321, whereby a document is created under operation of operation unit 33 while reference is made by the user to display 34. At this time, the user can operate operation unit 33 to instruct information processing apparatus 3 to make color parts of text red in the document that are desired to be emphasized. Control unit 31 creates document image data representing the document in a memory such as a RAM, based on operations performed by the user, and in accordance with procedures denoted in document creation application program 321. Control unit 31 is thus one example of an acquiring unit that acquires document image data by accordingly creating and storing document image data. Then, when the user instructs that the created document be printed by operation of operation unit 33, control unit 31 executes printer driver 322 to thereby initiate the processing shown in FIG. 4.

In FIG. 4, control unit 31 first analyzes the document image data and determines whether red that is to undergo emphasis support processing is present (step S41). The document image data contains color information representing various colors for representing text, diagrams, tables, and so on. By comparing color information with the red range denoted by printer driver 322, control unit 31 is able to identify document image data required to undergo emphasis support processing. This is done by comparing color information of the document data with a red range present in printer driver 322. If it is determined that red is present (step S41; YES), control unit 31 displays a pop-up window 5 in display 34 (step S42) to thereby enable the user to confirm whether emphasis support processing should be executed.

FIG. 5 is a diagram showing pop-up window 5. Pop-up window 5 includes radio buttons R51 and R52 that serve as an alternative input means for the user to initiate, as desired, emphasis support processing. The user can select either radio button R51 or radio button R52. Control unit 31 determines whether emphasis support processing should be performed based on an operation of operation unit 33 by the user (step S43). As shown in FIG. 5 in operation of operation of unit 33 by the user if radio button R51 indicating “yes” is selected by the user, followed by selection of a button B53 indicating “OK” located in the right-hand corner of the window (step S43; YES), control unit 31 displays a pop-up window 6 so as to enable the user to set details for implementation an emphasis support processing (step S44).

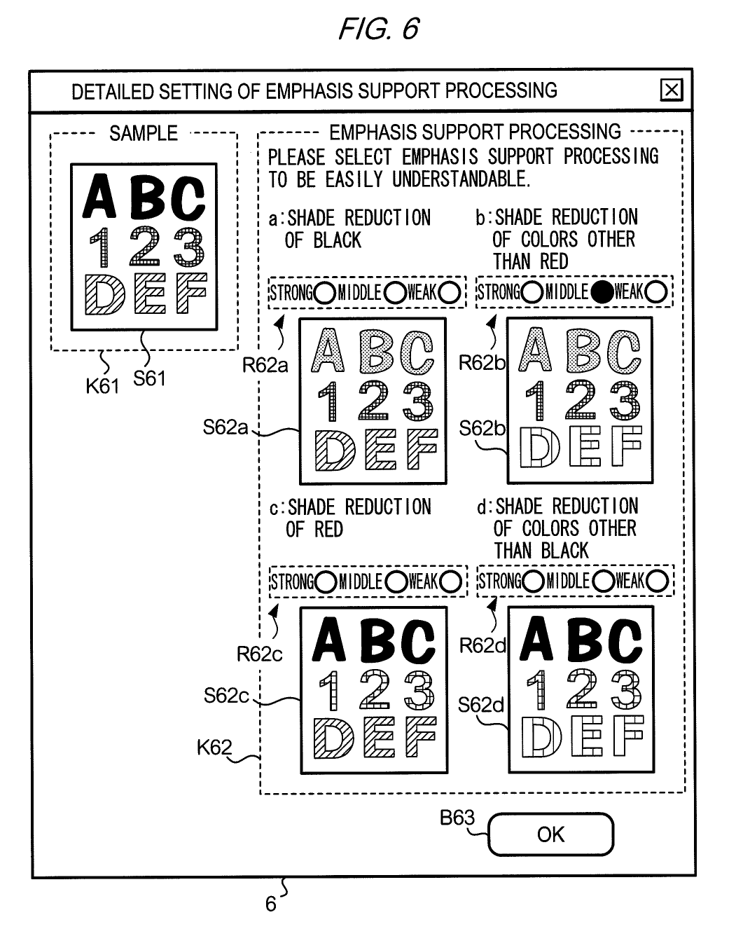

FIG. 6 is a diagram showing pop-up window 6. A sample image S61 (an example of an original image) is displayed in pop-up window 6 in a quadrangular region K61 surrounded by a broken line. Sample image S61 includes characters “ABC” in black, characters “123” in red, and characters “DEF” in green. Sample image S61 may be an image expressed by document image data created by a user, or an image expressed by sample image data (an example of original image data) denoted in printer driver 322 in advance. In FIG. 6 the latter example is illustrated. A quadrangular region K62 surrounded by broken lines is divided into 4 regions corresponding to 4 process modes of emphasis support processing, which are: “a: shade reduction of black,” “b: shade reduction of colors other than red,” “c: shade reduction of red,” and “d: shade reduction of colors other than black.” Radio buttons R62a to R62d and sample images S62a to S62d (an example of modified image) are displayed in these regions. Each of radio buttons R62a to R62d corresponds respectively to 3 shade reduction levels; namely, “strong,” “middle,” and “weak.” Sample images S62a to S62d are results of emphasis support processing applied to sample image S61. Control unit 31 displays images on which emphasis support processing is performed based on an instruction of a user by way of display 34 as processed sample images S62a to S62d. For example, if the radio button corresponding to the middle shade reduction level is selected by operation by the user of operation unit 33, those parts in the processed sample image S62b that include a colors other than red are shade reduced in sample image S61 to the “middle” level. Therefore, in the processed sample image S62b, “ABC” in black and “DEF” in green are displayed having reduced shades so as to be more clearly distinguishable than the shades in sample image S61. More specifically, densities of “ABC” and “DEF” in the processed sample image S62b are 54% of densities in the sample image S61 of “ABC” and “DEF” respectively. In other words, operation unit 33 is one example of an indicating unit that can be employed by user to indicate a density of an image performed under emphasis support processing.

A user may select either of the radio buttons in quadrangular region K62 surrounded by broken lines, to thereby view at display 34 a result of several kinds of emphasis support processing applied to a document before proceeding to print the document. In this way, color-blind individuals who have difficulty distinguishing red hues will at least be able to recognize a difference in red and colors other than red in the document. Therefore, in a case that shades of red, colors other than red, black or colors other than black are reduced, the densities of the colors become lower than densities of colors of other text present in the document, and thus color-blind individuals can readily distinguish between red and other colors, or between black and the other colors (this “other colors” includes red). This is for the following reason. The brightness difference between red and black is not great enough for color-blind individuals, who have difficulty distinguishing red hues, to distinguish those colors, so color-blind individuals have difficulty in distinguishing between red and black. However, if the densities of red or the other color(s) become low and a brightness difference between those colors becomes greater, color-blind individuals can easily distinguish those colors. For the same reason, it becomes easy to distinguish between black and the other color(s) (including red); and as a result it accordingly becomes easy to distinguish between red and the other color(s), whereby color-blind individuals are able to distinguish red images used for emphasis from images in the other color(s). Also, if red images are always included, and it becomes easy to distinguish between black and the other color(s) (such “other color(s)” always include red), color-blind individuals can distinguish black images most commonly used in a document from images in the other color(s) (including images provided in red for emphasis, rather than black).

Therefore, if a user is a color-blind individual, the user operates to select a radio button, whereby the user can view the processed sample images S62a to S62d, and select a level and a process mode of shade reduction to easily distinguish contents divided in colors. Color-blind individuals, who have difficulty distinguishing red hues, also tend to have difficulty distinguishing between green and other color(s). Therefore, sample image S61 and the processed sample images S62a to S62d include green, such that the user can distinguish not only red but also green. On the other hand, if a user is a typical individual with normal color vision, the user has to instruct implementation of emphasis support processing for a color-blind individual. However, the user may select emphasis support processing such that it can be readily understood not only by a color blind individual but also by an individual with normal color vision.

If emphasis support processing as shown in FIG. 6 is instructed by a user, more specifically, a radio button of radio buttons R62b, which is for selecting the “middle” level of the shade reduction in the process mode “b: shade reduction of colors other than red,” is selected, and furthermore selecting a button B63 indicating “OK” located in the right-hand corner of the window is selected, control unit 31 performs the selected emphasis support processing applied to document image data based on the color information, and thereby generates document image data (an example of modified image data) having a reduced density (step S45). In other words, control unit 31 is one example of a generating unit. Control unit 31 then performs an image processing for converting the document image data on which emphasis support processing has been carried out into image data in page description language, which can be processed by image-forming apparatus 1 (step S46). Next, control unit 31 sends the image data and an instruction to form an image based on that image data from communication unit 35 to image-forming apparatus 1 (step S47). When communication unit 15 of image-forming apparatus 1 receives the image data and the instruction from information processing apparatus 3, control unit 11 converts that image data to bitmap data and controls image-forming unit 17 to form the image on a recording medium.

Note that if in step S41, control unit 31 has determined that no characters written in red are present (step S41; NO), the processes of steps S42 to S45 are skipped, and the procedure advances to the image processing in step S46. Furthermore, if in step S43, radio button R52 indicating “no” is selected and button B53 indicating “OK” in that window is selected as a result of the user operating operation unit 33 (step S43; NO), control unit 31 skips the process in the aforementioned steps S44 to S45, and advances to the image processing in step S46.

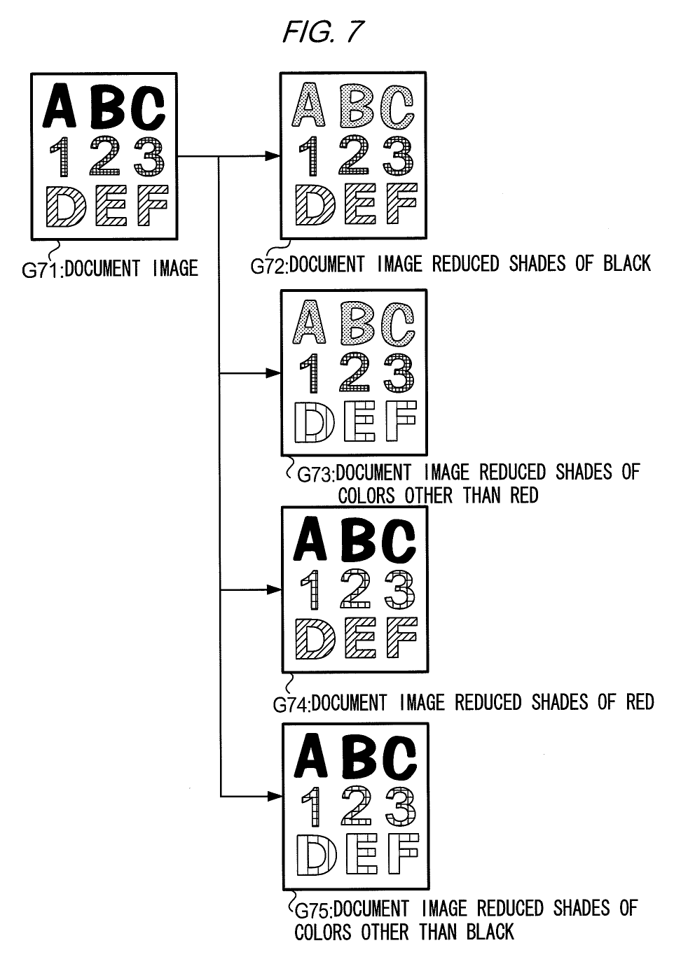

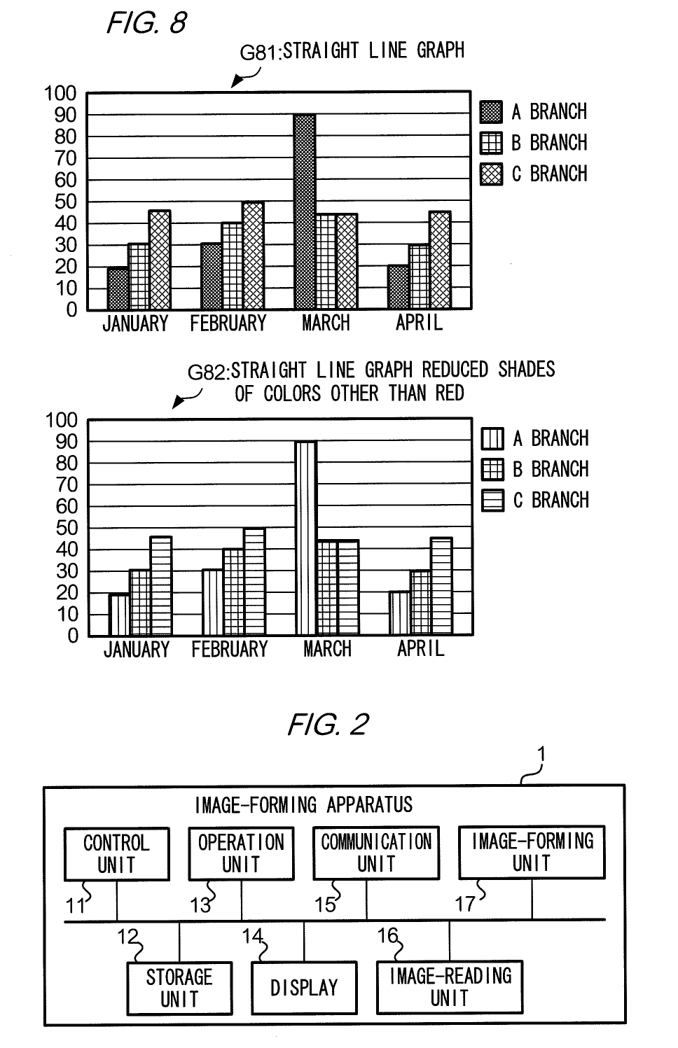

Here, FIG. 7 shows document images of a document after emphasis support processing. In FIG. 7, a document image G71 is a document image before performing of emphasis support processing, and document images G72 to G75 are document images after performing of emphasis support processing. Document image G71 is expressed in the same color scheme as sample image S61 in FIG. 6.

### (a: Shade Reduction of Black)

It is assumed that a user selects a radio button corresponding to the “middle” level of radio buttons R62a for selecting “a: shade reduction of black” as emphasis support processing, and furthermore selecting a button B63 indicating “OK” (referred to as “OK” button hereafter) in pop-up window 6. In this case, control unit 31 performs the shade reduction processing at the “middle” level applied to the characters “ABC” in black, in document image G71 in FIG. 7. By this process, a density of the characters “ABC” in document image G72 is 54% of the density of the characters “ABC” in document image G71. In FIG. 7, the characters “ABC” in document image G71 are painted out, while the characters “ABC” in document image G72 have a dot pattern applied. This shows that those characters have a density difference as described above (similar to document images G73 to G75). Note that when control unit 31 detects images in black, it may compare color information including image data with the black range defined by printer driver 322.

(b: Shade Reduction of Colors Other than Red)

It is assumed that a user selects a radio button corresponding to the “strong” level of radio buttons R62b for selecting “b: shade reduction of colors other than red” as emphasis support processing, and furthermore selecting the “OK” button in pop-up window 6. In this case, control unit 31 performs shade reduction processing at the “strong” level applied to the characters “ABC” in black and the characters “DEF” in green, in document image G71 in FIG. 7. By this process, densities of the characters “ABC” and “DEF” in document image G73 is 50% of the densities of the characters “ABC” and “DEF” in document image G71.

### (c: Shade Reduction of Red)

It is assumed that a user selects a radio button corresponding to the “weak” level of radio buttons R62c for selecting “c: shade reduction of red” as emphasis support processing, and furthermore selecting the “OK” button in pop-up window 6. In this case, control unit 31 performs the shade reduction processing at the “weak” level applied to the characters “123” in red, in document image G71 in FIG. 7. By this process, a density of the characters “123” in a document image G74 is 63% of the density of the characters “123” in document image G71.

(d: Shade Reduction of Colors Other than Black)

It is assumed that a user selects a radio button corresponding to the “middle” level of radio buttons R62d for selecting “d: shade reduction of colors other than black” as emphasis support processing, and furthermore selecting the “OK” button in pop-up window 6. In this case, control unit 31 performs the shade reduction processing at the “middle” level applied to the characters “123” in red and the characters “DEF” in green, in document image G71 in FIG. 7. By this process, densities of the characters “123” and “DEF” in a document image G75 are 54% of densities of the characters “123” and “DEF” in document image G71.

### Modified Example

In the foregoing exemplary embodiment, the example that control unit 31 determines “character” to undergo emphasis support processing is described, but a target of emphasis support processing is not limited thereto, and may, for example, be diagrams, line drawings that represent tables, and so on.

FIG. 8 is a diagram showing an image after emphasis support processing. In a straight line graph G81 in FIG. 8, “straight lines corresponding to A branch” is expressed in black, “straight lines corresponding to B branch” is expressed in red, and “straight lines corresponding to C branch” is expressed in green. It is assumed that a user selects the radio button corresponding to the “strong” level of radio buttons R62b for selecting “b: shade reduction of colors other than red” as emphasis support processing, and furthermore selects the “OK” button in pop-up window 6. In this case, control unit 31 performs the shade reduction processing at the “strong” level applied to the “straight lines corresponding to A branch” in black and the “straight lines corresponding to C branch” in green, in straight line graph G81 in FIG. 8. By this process, densities of the “straight lines corresponding to A branch” and “straight lines corresponding to C branch” in straight line graph G82 are 50% of the densities of the “straight lines corresponding to A branch” and “straight lines corresponding to C branch” in straight line graph G81.

As described above, a target of emphasis support processing can be characters, diagrams, line drawings such as tables, or any information in which red may be used among other colors and that a user is required to be able to distinguish.

In the foregoing exemplary embodiment, there are 4 process modes, shade reduction of red, colors other than red, black and colors other than black, but it is not necessary that information processing apparatus 3 includes all of those 4 process modes. As described above, when red shades or colors other than red are reduced, images in red used for emphasis and images in colors other than red can be readily distinguished; and thus the effect can be realized where information processing apparatus 3 reduces only red shades or reduces colors other than red. Also, in a case that a document includes red, when shades of either black or colors other than black are reduced, images in black, which is the color most commonly used in documents, can be readily distinguished; and, moreover, images in colors other than black, for example, those that include red for emphasis can also be distinguished readily. Therefore, information processing apparatus 3 may reduce red shades or colors other than red, or may reduce black shades or colors other than black.

Also, in the exemplary embodiment, it is assumed that while black is most commonly used in documents, but a color other than black may be used also, depending on a purpose of text in the document. If a color other than black is actually most commonly used in a particular document, a color range of that color is defined by printer driver 322 instead of the black range. It is to be noted that the color range need not be specified for printer driver 322 in advance, but rather control unit 31 may be used to analyze color information including image data and thereby specify a color most used in the document. The most used color is specified as a color other than a background color (typically, white) of an image.

Further, albeit rarely, a case may occur where red is a color most commonly used in a particular document. In such a case, a reduction in red shade or a reduction in shade of another color(s) appearing in the document can be implemented to thereby provide a difference in density between the red and the other color(s), to thereby enable a color blind individual to distinguish without difficulty the red and other color portions of the document.

In the foregoing exemplary embodiment, emphasis support processing is carried out by control unit 31 of information processing apparatus 3 executing printer driver 322. However, the entity that performs emphasis support processing, the program in which the procedure for emphasis support processing is denoted, and so on are not limited thereto. The procedure for emphasis support processing may be denoted in a program different from printer driver 322, such as, for example, the document creation application program stored in information processing apparatus 3, or may be denoted in a computer program stored in image-forming apparatus 1. In the latter case, image-forming apparatus 1 executes emphasis support processing, and thus, for example, emphasis support processing can be carried out on image data representing an image read by image-reading unit 16 as well. Therefore, it is also possible, when making a photocopy, to create a copy in which it is easy for a color-blind individual to distinguish red from other color(s).

Furthermore, instead of performing emphasis support processing by control unit 31 under execution of a software program by processing apparatus 3 emphasis support processing may be performed by an analog circuit, such as an ASIC (Application Specific Integrated Circuit), without a need for use of such a program.

The red range can also be defined using an arbitrary color space aside from the RGB color space; in other words, as long as the red range is a range that is difficult for color-blind individuals to distinguish from other color(s), any color space may be used. For example, the range may instead be defined in the HLS color space, which expresses colors through three elements, or hue, saturation, and lightness. When using the HLS color space, the red range may be defined as, for example, H=250 to 255 and 0 to 8, L=220 to 255, and S=118 to 153. The black range is also not limited to the example described in the exemplary embodiment.

Also, In FIG. 6, sample image S61 and processed sample images S62a to S62d include images in green for the user to be able to distinguish not only red but also green, but displaying these images in green is not essential.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image-processing apparatus comprising:
a memory that stores a red range defining red in a color space;
an acquiring unit that acquires original image data representing an original image including a first part whose color is the red defined by the red range and a second part whose color is a color other than the red; and
a generating unit that generates modified image data representing a modified image in which a density of either the first part or the second part is reduced to a density smaller than a density of the original image represented by the acquired original image data.

2. An image-processing apparatus comprising:
a memory that stores a red range defining red in a color space;
an acquiring unit that acquires original image data representing an original image including a first part whose color is a most frequently occurring color in the original image and a second part whose color is a color other than the most frequently occurring color; and
a generating unit that generates modified image data representing a modified image in which a density of either the first part or the second part is reduced to a density smaller than a density of the original image represented by the acquired original image data, if the original image represented by the original image data includes a part whose color is the red defined by the red range.

3. An image-processing apparatus comprising:
a memory that stores a red range defining red and a black range defining black in a color space;
an acquiring unit that acquires original image data representing an original image including a first part whose color is the black defined by the black range and a second part whose color is a color other than the black; and
a generating unit that generates modified image data representing a modified image in which a density of either the first part or the second part is reduced to a density smaller than a density of the original image represented by the acquired original image data, if the original image represented by the original image data includes a part whose color is the red defined by the red range.

4. The image-processing apparatus according to claim 1, further comprising an indicating unit that indicates the reduced density.

5. The image-processing apparatus according to claim 2, further comprising an indicating unit that indicates the reduced density.

6. The image-processing apparatus according to claim 3, further comprising an indicating unit that indicates the reduced density.

7. The image-processing apparatus according to claim 4, further comprising a display controller that controls a display to display the modified image represented by the modified image data having the density indicated by the indicating unit.

8. The image-processing apparatus according to claim 5, further comprising a display controller that controls a display to display the modified image represented by the modified image data having the density indicated by the indicating unit.

9. The image-processing apparatus according to claim 6, further comprising a display controller that controls a display to display the modified image represented by the modified image data having the density indicated by the indicating unit.

10. An image-forming apparatus comprising:
a memory that stores a red range defining red in a color space;
an acquiring unit that acquires original image data representing an original image including a first part whose color is the red defined by the red range and a second part whose color is a color other than the red;
a generating unit that generates modified image data representing a modified image in which a density of either the first part or the second part is reduced to a density smaller than a density of the original image represented by the acquired original image data; and
an image-forming unit that forms on a medium the modified image represented by the modified image data generated by the generating unit.

11. An image-forming apparatus comprising:
a memory that stores a red range defining red in a color space;
an acquiring unit that acquires original image data representing an original image including a first part whose color is a most frequently occurring color in the original image and a second part whose color is a color other than the most frequently occurring color;
a generating unit that generates modified image data representing a modified image in which a density of either the first part or the second part is reduced to a density smaller than a density of the original image represented by the acquired original image data, if the original image represented by the original image data includes a part whose color is the red defined by the red range; and
an image-forming unit that forms on a medium the modified image represented by the modified image data generated by the generating unit.

12. An image-processing method comprising:
storing a red range defining red in a color space;
acquiring original image data representing an original image including a first part whose color is the red defined by the red range and a second part whose color is a color other than the red; and
generating modified image data representing a modified image in which a density of either the first part or the second part is reduced to a density smaller than a density of the original image represented by the acquired original image data.

13. An image-processing method comprising:
storing a red range defining red in a color space;
acquiring original image data representing an original image including a first part whose color is a most frequently occurring color in the original image and a second part whose color is a color other than the most frequently occurring color; and
generating modified image data representing a modified image in which a density of either the first part or the second part is reduced to a density smaller than a density of the original image represented by the acquired original image data, if the original image represented by the original image data includes a part whose color is the red defined by the red range.
